(19) United States
(12) Patent Application Publication
(10) Pub. No.: US 2026/0011489 A1
(43) Pub. Date: Jan. 8, 2026

(54) IMPROVED SUPERCONDUCTING MAGNET REINFORCEMENT

(71) Applicant: OXFORD INSTRUMENTS NANOTECHNOLOGY TOOLS LIMITED, Abingdon, Oxfordshire (GB)

(72) Inventors: Steven BALL, Abingdon, Oxfordshire (GB); Andrew TWIN, Abingdon, Oxfordshire (GB); Ben BRYANT, Abingdon, Oxfordshire (GB); David WARREN, Abingdon, Oxfordshire (GB)

(21) Appl. No.: 18/993,358

(22) PCT Filed: Jul. 12, 2023
(86) PCT No.: PCT/GB2023/051825

§ 371 Date: Jan. 10, 2025

(30) Foreign Application Priority Data
Jul. 12, 2022 (GB) 2210244.6

(51) Int. Cl. H01F 41/04; H01F 6/06; H01F 41/06

(52) U.S. Cl. CPC H01F 41/048; H01F 6/06; H01F 41/06

(57) ABSTRACT

A method of reinforcing a superconducting magnet coil is described. The method comprises obtaining a superconducting magnet coil having a plurality of turns of a superconducting material wound on a former having a first longitudinal axis so as to define an external circumferential surface of the coil, winding at least one elongate filament, under a tension of at least 10×10⁶ Pa, around a second longitudinal axis a plurality of times so as to form a band of filament, and disposing the band of filament around the external circumferential surface of the coil such that, when the coil is in use, the band of filament resists radial expansion of the superconducting magnet turns. The at least one elongate filament is formed from a material having an elastic modulus greater than 2.2×10¹¹ Pa, a yield strength greater than 6×10⁸ Pa, and a density less than 4×10³ kgm⁻³. A reinforced magnet coil is also described.

### FIELD OF THE INVENTION

The present invention relates to reinforcement of a superconducting magnet coil by way of a band of filament disposed around the external circumference of the coil.

### BACKGROUND

Superconducting magnets are characterized by large fields and current densities. As a result, coils of such magnets are subjected to strong electromagnetic forces and experience large stresses. In particular, the forces exerted on a coil in use lead to large strain in the coil, particularly in the hoop direction, namely along the length of the coil turns or wire therein, in the tangential (azimuth) direction. This strain limits the maximum superconducting current and the field quality that can be achieved by the magnet, and additionally can cause mechanical degradation and deformation in the coil.

A known technique for controlling hoop stress is to use steel as a reinforcing material. Stainless steel has been used in reinforcing members disposed over the outside of coils to control the forces that act to expand the coil in the radial direction. Such reinforcement structures have been used for this purpose with both low-temperature superconductor (LTS) and high-temperature superconductor (HTS) coils. The amount of stainless steel (or similar supporting material) required depends on the forces on the coils and the tensile strength of the supporting material.

A drawback with such existing support structures is that the reinforcing material occupies space that could otherwise contain more superconducting material, while adding more reinforcing material of the same type gives diminishing returns in terms of strain reduction. An improved type of coil reinforcement would provide benefits for various types of superconducting magnet.

In high field all-superconducting magnets (above ˜23 T) it is typically necessary to use some HTS materials for the inner windings of the magnet. Outside of these inner windings where the field is lower, the use of LTS materials, which are less costly than HTS materials, is preferable.

In a cryogen-free system it is also necessary to provide a path of thermal conduction of conductive materials from the coils to the source of cooling.

There exists a need for an improved way of reinforcing superconducting magnet coils against hoop stresses, which would allow coils to operate at a higher current for the same given cross-section of coil winding. In particular there is a desire for an improved approach to reinforcement by which the volume and mass of reinforcing material required in high-field magnets would be reduced. This would, in turn, allow the outer coils to be positioned closer to the magnet centre, which would reduce the quantity of superconducting material required for a given field, further reducing the size and mass of the coils.

### SUMMARY OF INVENTION

In accordance with a first aspect of the invention there is provided a method of reinforcing a superconducting magnet coil, comprising: obtaining a superconducting magnet coil having a plurality of turns of a superconducting material wound on a former having a first longitudinal axis so as to define an external circumferential surface of the coil; winding at least one elongate filament, under a tension of at least 10×10⁶ Pa, around a second longitudinal axis a plurality of times so as to form a band of filament; and disposing the band of filament around the external circumferential surface of the coil such that, when the coil is in use, the band of filament resists radial expansion of the superconducting magnet turns, wherein the at least one elongate filament is formed from a material having an elastic modulus greater than 2.2×10¹¹ Pa, a yield strength greater than 6×10⁸ Pa, and a density less than 4×10³ kgm⁻³, wherein the method further comprises, prior to the winding of the at least one elongate filament, winding a sheet of material around the external circumferential surface of the coil such that the at least one elongate filament is wound around an external circumferential surface of the wound sheet of material.

The inventors have realised that high-modulus filaments can advantageously be used to provide improved support for superconductive coils against hoop stress, while allowing greater overall current density within the magnet to be achieved, and while also allowing for higher central fields and more compact coils with less expensive superconducting wire types. In this way, high-field magnets in which the coils are subjected to large electromagnetic forces may be made more compact, thereby reducing costs and enhancing performance and overcoming the shortcomings of existing coil reinforcement means. Additionally, the disclosed approach to reinforcement allows practical support of high-temperature superconductor (HTS) materials in the inner sections of very high-field magnets.

The method can advantageously employ this application of a band of filament around the outside surface of a magnet coil, in a process that may be described as over-banding enables these improvements with respect to the known magnet reinforcement constructions. Thus the use of high-modulus, high-strength, low-density filaments or fibres wound around the outside of a superconducting coil under tension can, it has been found, provide sufficient mechanical support to reduce or prevent deleterious effects and damage to coils caused by electromagnetic forces, in particular hoop stress or bursting stress, to which such coils are subjected in use. It will be understood that the term “superconducting material” in the context of this disclosure may refer to any superconductive material suitable for use in a magnet coil. That is, the material of the coil may be understood as being a substance capable of becoming superconducting at sufficiently low temperatures. As is described later in this disclosure, the advantageous reinforcement approaches now described are applicable to various types of superconductive coil, and so the sufficiently low temperatures may differ across various embodiments. This improved resistance against stresses is achieved also with the winding of the sheet of material around the external circumferential surface of the coil, prior to the winding of the at least one elongate filament. Thus the at least one elongate filament is wound around an external circumferential surface of the wound sheet of material. The sheet may be understood as a piece of material having a thickness significantly smaller than its breadth and/or length, as is well understood in the art.

The plurality of turns of the superconducting material being wound on a former may be understood as the coil having been formed in that way, with the former itself typically remaining in place during the winding of the elongate filament. It may refer specifically to the magnet coil remaining in situ, wound on the former during the subsequent winding or other processing steps. The former generally has the form of a substantially cylindrical rod around which the coil material or other materials may be shaped. The rod or other former may be solid, or alternatively may be hollow, that is defining an interior volume within.

The magnet coil itself may be thought of as having a longitudinal axis coincident with the longitudinal axis of the former, that is the first longitudinal axis. In particular the coil may be understood as having windings that are wound about that longitudinal axis. Typically, therefore the longitudinal axis of the former and that of the magnet coil are one and the same while the magnet coil is being shaped.

The circumferential surface of the coil may be understood as denoting the circumference of the turns of the magnet coil, in particular the circumference of the curve of the plurality of turns, or a projection thereof on a plane perpendicular to the longitudinal axis of the coil. In other words, the circumference to which that term refers may be understood as relating to the circumference of the winding about the longitudinal axis. This may be thought of as a radially outer surface, that is a surface that is an outward-facing surface, that is typically distal to, or facing away from, the central longitudinal axis of the coil and the former.

In some embodiments, typically in dependence on the cross-section of the coil in the plane perpendicular to the circumferential direction or the coil winding direction, the band of filament may extend beyond the most outwardly facing surface or portion of coil surface. That is to say, a surface, or a portion of the surface, of the magnet coil that is radially most distant from the centre of the coil, or from the longitudinal axis may underlie, at least with respect to alignment or registration in radial directions, a portion of, or all of, the band of filament.

In this context, and generally throughout this disclosure, the term “circumferential” may therefore be understood as referring to the outer curve of turns of the coil about the longitudinal axis of the coil, typically corresponding to the direction of windings about the longitudinal axis of the former and/or the magnet coil.

Likewise, unless otherwise stated, in this disclosure the term “axial” may be understood as relating to a direction parallel to the longitudinal axis of the coil, that is the axis about which the magnet coils are wound. Similarly, the term “radial” as used in this disclosure may, unless otherwise stated, be understood as referring to directions coplanar with, but perpendicular to the longitudinal axis of the magnet.

The surface of the coil may be defined by outer surfaces of windings of the superconducting material. In most embodiments, the coil outer surface may be defined by the outer surface of an insulation material, for example a ceramic insulation layer disposed over or around lengths of superconductive material or around individual superconducting wires comprised by a coil winding. The said surface may also be defined by an outer surface of a resin material with which the coil may be impregnated. Similarly, alternative filler materials to resin materials may be used.

Although a single elongate filament may be used in forming the band of filament, typically a plurality of elongate filaments are wound together in order to provide the reinforcement for the coil through a more rapid process. Preferably, therefore, multiple elongate filaments are formed into a strand, which may also be referred to as a roving or a tow. In typical embodiments, this may be understood as a (typically loose) assemblage of filaments in a single strand. The filaments may be untwisted, or substantially so. Alternatively, an assembly of multiple filaments may be used for the windings in which one or more strands are twisted together.

This disclosure additionally makes reference to fibres. In this context, a fibre may be understood as being a thread-like structure having a length significantly greater than its diameter, for example at least 100 times its diameter. Fibres may be of definite short lengths, or may be continuous. A filament may be thought of as a single fibre, and typically a fibre having extreme length. Preferably, the method involves winding a thin thread of material, or a slender, thread-like object, that comprises at least one elongate filament, under the stated degree of tension, in order to form the band of filament. A filament may have a substantially round cross-section (in a plane perpendicular to its longitudinal direction), and may have a width or cross-sectional diameter in the order of several micrometres, for example 5 or 10 micrometres. Thus the filament wound around the magnet may have an extent, in the magnet axial or longitudinal direction, which is several orders of magnitude smaller than that of a magnet coil or a section of sheet material wound around the coil.

In addition to winding multiple filaments together as part of an elongate assembly of filaments such as a strand or yarn, a tape comprised of elongate filaments may also be used, namely a strip of material comprising a plurality of fibres arranged at least side by side in a direction transverse to their length and the direction of the individual coil windings such that the length of filament material itself has an axial extent greater than its radial extent.

The tension under which the at least one elongate filament is wound enables the beneficial resistance to bursting stress to be achieved. In some embodiments, the filament is wound under a tension of at least 5×10⁷ Pa. In some embodiments the tension is at least 1×10⁸ Pa, or at least 1×10⁹ Pa. A tension may be chosen or maintained within a range of values between any two of the winding tension values specified in the preceding part of this disclosure.

Preferably, each filament is wound around the entire outside circumference of the coil many times, in particular because in preferred embodiments the filament or strand of filaments has a length that is many times greater than the coil circumference. Typically, each individual turn of the coil is therefore over-wrapped with many turns of a single filament or strand. The winding of the filament may comprise winding a single filament, or a plurality of individual filaments one-at-a-time. The winding may alternatively involve winding a plurality of filaments simultaneously. In some embodiments the plurality of filaments may be combined into a filament assembly such as a thread, yarn, tow, or roving, and a filament assembly may be wound individually or together with other filament assemblies, analogously to the single-filament approach.

During the winding of the filament, the filament or strand is typically caused to traverse the coil or the former in an axial direction so as to produce a band having axial extent. Typically, this axial extent is greater, preferably by one or more orders of magnitude, than that of the filament or strand. In some embodiments, the filament may be disposed directly on the coil, so as to be in contact with the outermost layer of coil. Typically, however, the outer layer comprises an insulation layer such as a ceramic, as noted above. Alternatively, the method may involve disposing the band of filament around the coil with a further band, layer, film, or further strands disposed between the coil and the one or more elongate filaments. The term “external” as used in reference to the external circumferential surface of the coil may be understood as referring to an outer surface of the coil, that is to say that the band is typically formed over the outside of the coil. The term “circumferential” as explained earlier in this disclosure may accordingly be understood as referring to the specific outer surface or surface portion that is radially most distant from the longitudinal coil axis.

The produced band of filament, which may be called a reinforcement band, may advantageously be resistant to expansion caused by forces that are generated while the coil is in use. However, additionally, in some embodiments, the tension in the reinforcement band may put the coil under some degree of compression in absence of these forces. However, when the coil is cooled to its operating temperature, the coil typically contracts radially, relative to its dimensions when energised at high temperatures. The radial expansion referred to above may be thought of as expansion of the coil in the radial direction with respect to the coil, and particularly the turns thereof. That is, it may be understood as referring to expansion of coil material away from the centre, or central longitudinal axis, of the coil.

The above noted elastic modulus, yield strength, and density properties may be understood as being possessed by any one or more of the at least one elongate filament individually, an elongate assembly of such filaments such as a tow or strand of filaments, and the formed band of filament. Typically, the filament or strand possesses these properties at the winding stage, since the properties of the filament material itself are typically unaltered or substantially unchanged by the reinforcement process or any coil production steps performed after the band is wound. The use of such high-strength and high-stiffness materials having such low densities enables the coil to be reinforced robustly while providing a reinforcement band having a low mass, and low thermal mass, compared to conventional arrangements. In this way, the reinforcement band contributes less mass to be cooled down in operation, and less mass to support.

In preferred embodiments, the band of filament is formed around the magnet coil. In this way, in accordance with a second aspect of the invention there is provided a method of reinforcing a superconducting magnet coil, comprising: obtaining a superconducting magnet coil having a plurality of turns of a superconducting material wound on a former having a first longitudinal axis so as to define an external circumferential surface of the coil; winding at least one elongate filament, under a tension of at least 10×10⁸ Pa, around a second longitudinal axis a plurality of times so as to form a band of filament; and disposing the band of filament around the external circumferential surface of the coil such that, when the coil is in use, the band of filament resists radial expansion of the superconducting magnet turns, wherein the at least one elongate filament is formed from a material having an elastic modulus greater than 2.2×10¹¹ Pa, a yield strength greater than 6×10⁸ Pa, and a density less than 4×10³ kgm⁻³.

The second aspect may correspond to an embodiment of the first aspect in which the first longitudinal axis is the same as the second longitudinal axis and the winding of the at least one elongate filament forms, or is around the external circumferential surface of the coil so as to form, the band of filament disposed around the external circumferential surface of the coil.

Although it is preferred that the band of filament be wound in situ, in some embodiments the band can be formed separately and subsequently transplanted onto the coil. Therefore, in some embodiments according to the first aspect, the second longitudinal axis is a longitudinal axis of a second former, which is typically different from the first former, but in some embodiments may be one and the same, identical, or similar. The second former may be removable, and is typically a cylindrical former, or comprises a cylindrical forming portion. Preferably, any suitable former may be used, with dimensions, particularly a radius, identical or similar to, and typically smaller than, that of the coil. Preferably, the second former has an external circumferential surface corresponding or conforming to that of the coil, or substantially so. For example, the former may therefore have a radius and/or circumference smaller than those of the coil by a degree that enables the band to be transferred to and retained around the coil by an interference fit.

In such embodiments, the winding of the at least one filament forms the band of filament around the external circumferential surface of the second former, or the filament may be wound so as to form the band around the former. In such cases the method may further comprise removing the formed band of filament from the former and disposing it around the external circumferential surface of the coil.

In variations upon this embodiment of the second aspect, the method may further comprise disposing a filler material, such as a resin or wax, on the second former so as to form a rigid assembly comprising the filler material and the band of filament. The wound band may be impregnated with a filler, or a filament may be wet wound with the filler. The filler may subsequently be hardened or solidified to form the assembly. The rigid assembly may be understood as an assembly, preferably one that is rigid or at least sufficiently rigid to enable the assembly to be transferred to the coil intact. The rigid assembly typically has the form of a shell defining an internal volume of suitable size and shape for receiving the coil.

In such embodiments the method may include removing the second former from the assembly, and inserting the coil into the assembly so as to dispose the formed band of filament around the external circumferential surface of the coil.

The subsequently described embodiments may relate to either or both of the first and second aspects.

Generally, when an assemblage of filaments, such as a strand, is used, the at least one filament having the properties set out above may be understood alternatively or additionally as the assemblage having those properties. Therefore, preferably the filament is wound by way of winding around the longitudinal axis at least one elongate strand of filaments, the strand being formed from a material having an elastic modulus greater than 2.2×10¹¹ Pa, a yield strength greater than 6×10⁸ Pa, and a density less than 4×10³ kgm⁻³. Thus, in some embodiments, the winding the at least one elongate filament comprises winding at least one elongate strand comprising the at least one elongate filament, under a tension of at least 10×10⁶ Pa, around the first longitudinal axis a plurality of times so as to form the band of filament. Typically in such embodiments each of the at least one elongate strand comprises a plurality of elongate filaments. Typically each strand comprises a plurality of filaments of the same or a similar type and/or material. Alternatively to a strand, an assemblage of multiple filaments having the form of a tape or a strip comprising one or more filaments may be used.

The strand or other type of assemblage of filaments is typically selected with a size or dimensions appropriate for the dimensions of the magnet coils or wires thereof. For example, the diameter or minimum thickness of the strand or tape may typically be less than that of a superconducting wire or tape comprised by the superconducting coil turns. A typical thickness of a filament tape or strand diameter is 0.1-0.5 mm. In typical embodiments, such strands or tapes may have lengths greater than 10 metres, more preferably greater than 100 metres.

The advantageous resistance to coil expansion and hoop stress described above may be understood as being provided by the high modulus and yield strength of the reinforcement band material. Both carbon and alumina are materials that are well suited to being formed into filaments that possess these qualities. Moreover, such materials can afford a reinforced coil with the necessary support without the disadvantages, such as high mass and thermal bulk, of previously used reinforcing materials such as steel. Alternatively or additionally, the elongate filaments may comprise fibre filaments of any suitable material that provides the strand with the said elastic modulus, yield strength, and density. However, in preferred embodiments, each of the at least one elongate strand, or the said material from which the strand or strands are formed, comprises a plurality of carbon fibre filaments and/or a plurality of alumina fibre filaments. The filament may comprise any one or more of: alumina, carbon fibre, a polymer material such as poly (p-phenylene-2,6-benzobisoxazole) (PBO), commonly referred to as Zylon®, and Kevlar® (Poly (azanediyl-1,4-phenyleneazanediylterephthaloyl)). Preferably the filament does not comprise, or is formed from a material that does not comprise, a metal material or a metal alloy.

Typically the strand is or comprises a tow or roving formed from a plurality of filaments. A filament may be understood as comprising an individual fibre, as noted above. Typically, a length of strand comprises several, preferably several thousand, continuous filaments bundled together. In preferred embodiments, the filaments are continuous, or substantially so, along a given length of strand, or along the majority or the entirety of a length of strand that is wound around the longitudinal axis to form the band. This continuity may exist at least for lengths of the order of the total length of a complete turn of the magnet or the outer circumference thereof, and more preferably the filaments are continuous along a length greater than or equal to two or more turns, or for all turns, or for a multiple of the number of magnet coil turns.

In accordance with the beneficial use of these materials, a method according to a third aspect of the invention is provided, the method comprising obtaining a superconducting magnet coil having a plurality of turns of a superconducting material wound on a former having a first longitudinal axis so as to define an external circumferential surface of the coil; winding at least one elongate filament, under a tension of at least 10×10⁶ Pa, around a second longitudinal axis a plurality of times so as to form a band of filament; and disposing the band of filament around the external circumferential surface of the coil such that, when the coil is in use, the band of filament resists radial expansion of the superconducting magnet turns, wherein the at least one elongate filament comprises a carbon fibre filament or an alumina fibre filament. Preferably, as noted above, filaments are wound in the form of an assemblage, and therefore the method preferably comprises winding a strand of carbon fibre filaments or alumina fibre filaments.

The subsequently described embodiments are applicable to any of the first, second, and third aspects of the invention.

Preferably, the elongate filament in the band of filament, or the plurality of fibre filaments more preferably, is aligned circumferentially, or substantially circumferentially, with respect to the magnet coil. Reinforcement against radial expansion and bursting stress in the magnet coils may generally be achieved by providing a strand in which the fibre filaments are aligned, or substantially aligned, with the strand itself, or along the length of the strand. This is typically the construction of tows and rovings of filaments. Thus in some embodiments the advantageous resistance to expansion and coil stresses may be achieved by winding the strand such that the strand itself is aligned substantially circumferentially with respect to the magnet coil.

It will be understood that the winding of the filament or strand may be controlled so as to effect an angle between the circumferential direction of a coil winding and the filament or strand. In this way, the term substantially circumferentially may be understood as referring to the filaments being aligned substantially parallel to the azimuthal direction, such that some deviation of the order of a few degrees is permitted. In particular, the maximum angle subtended by a filament and a coil winding may be no greater than 10 degrees in some embodiments. Preferably, in the formed band of filament, the orientation of strands and/or fibre filaments therein is such that the fibre filaments are substantially parallel to the turns of the magnet coil. Typically the length of the fibres is such that each of a plurality of continuous filaments extends around the outer circumference of the magnet multiple times, as described earlier in this disclosure. The permitted deviation between the fibre orientation and the azimuthal direction may be chosen so as to maximise the alignment between the filaments and the circumferential direction while traversing the filament being wound along the axial direction.

In its context, it will be recognised that mechanical support may be enhanced by orienting the fibre filaments so that one or more filaments or pluralities of filaments encircle, or at least partially encircle, the outer circumference of the coil. Moreover, since the abovementioned advantageous mechanical properties of the fibre filaments are typically exhibited in their elongate direction, which may be understood as being by virtue of fibres having a continuous extent in that direction, applying the filaments with this azimuthal orientation maximises the extent to which the beneficial material properties of the fibres are directed at alleviating radial expansion and hoop stresses particularly.

Such alignment allows the longitudinal (with respect to the filaments, stiffness and strength of the fibre filaments), in other words, which serve to restrict extension of the fibres in the azimuthal or near-azimuthal directions along which they are disposed, to oppose radial expansion of the coil, since such expansion would act upon the fibres to extend them along their length. Therefore the winding is preferably controlled such that the wound plurality of fibre filaments in at least one, or a subset of, or preferably all of, the one or more strands, are oriented such that the angles subtended by a plane perpendicular to the longitudinal axis of the coil and a direction tangential to the fibre along its length at any given point on the fibre does not exceed a predetermined maximum angle. Preferably the maximum angle is 10 degrees.

In the context of such embodiments, the substantially circumferential alignment of the at least one filament may be thought of as the filament or filaments being substantially parallel with the coil windings. This will be understood as those filaments being parallel or generally aligned along a curve, typically a helix or circle. It will also be understood in view of the above explanations that the substantially circumferential alignment of the fibre filaments in the band with respect to the magnet coil corresponds to those filaments being aligned circumferentially or azimuthally around the longitudinal axis of the former and/or the magnet coil, which in some embodiments may be different or the same, depending upon the order of production steps.

In some embodiments, the method further involves one or more layers of material being interposed between the coil outer surface and the band of filament. Layers comprised by the one or more layers may be formed from or comprise the same material or different materials. This can helpfully provide effects such as heat dissipation and improved ease of manufacture of the band.

In various embodiments the sheet that is wound around the coil may comprise one layer or a plurality of layers. In the latter case two or more of the plurality of layers, or all of the plurality of layers, may be formed from or comprise the same material. It is also envisaged that some or all layers comprised by the plurality of layers may comprise or be formed from different materials.

Preferably the band of filament around the external circumferential surface of the coil such that the formed band of filament defines an external surface of the reinforced coil. That is, the band of filament preferably defines the radially outermost surface of the reinforced magnet, and faces an environment external to the magnet, that is with no additional external layers being applied thereto. Thus preferably the formed reinforced magnet, or a coil thereof, comprises a wound sheet having a first surface and a second surface opposite the first surface, and a band of filament having a first surface and a second surface opposite the first surface, wherein the sheet is closer to the magnet coil than the band of filament, and the band of filament is closer to the external environment than the sheet, wherein the first surface of the sheet faces the magnet coil, the second surface of the sheet faces the first surface of the band of filament, and the second surface of the band of filament faces an environment external to the reinforced coil.

Typically the extent of the sheet, and at least one dimension, typically its breadth and/or length, is greater than or equal to a spacing in the axial direction between, or to a gap defined between, adjacent, typically immediately adjacent, superconducting wires in a coil winding. Depending upon the type of magnet coil provided, if the coil windings comprise individual wires that define an outer surface of the coil to which the band of filament is directly applied, winding a sheet material can advantageously cover the gap or spacing in order to prevent strands or filaments being wound between the superconducting wires. Preferably the extent, that is the width transverse to the winding direction, of the sheet is sufficiently great to cover multiple inter-wire gaps. More preferably the sheet has a breadth in the axial direction, or the transverse winding direction is sufficient to cover multiple or all windings. As explained above, the axial direction maybe understood as a direction parallel to the longitudinal axis of the magnet coil and/or former. The axial direction of the magnet typically corresponds to the transverse direction of the sheet being wound.

In embodiments wherein the band is formed on a former separate from the magnet and then transferred to the latter, one or more sheets may be wrapped around either or both of the second former and the coil.

The use of a sheet of material comprising a fabric woven from fibres having similar or identical properties to those of the band of filament, or formed from or comprising the same material as the band of filament, is employed in some embodiments. The method may, in some embodiments, therefore involve the sheet comprising a fabric woven from carbon fibre filaments and/or alumina fibre filaments, such as a fibre cloth comprising either or both of those fibres. The sheet may comprise a layer formed from any one or more of: carbon fibre filaments, alumina fibre filaments, alumina cloth, aluminosilicate/alumina silica cloth, E glass or other heat resistant glass cloth, silica cloth, ceramic cloth, polysilisic acid material, hydrated silica fibre or silica gel such as Belcotex® (SIAOXOL).

Although providing such an intervening layer made of similarly stiff, light, and strong fibres is beneficial for the operation and manufacture of the roving force coil, the use of this layer in combination with the elongate filament band is particularly advantageous. Typically, the sheet is wound under a lesser degree of tension than the one or more elongate filaments that form the band of filament. Moreover in such a sheet the fibre filaments are typically oriented in multiple directions, and therefore a given amount, or applied area, of sheet material is typically less suited to act against hoop stresses and radial expansion than an equally sized area of reinforcement band, since the filaments in the latter are typically aligned entirely azimuthally or substantially so. Further enhancement to the reinforced coil may be achieved by way of providing a comparatively resistant material between the coil and the strand band. This is particularly beneficial in embodiments wherein the strand or filament material possesses a degree of electrical conductivity that is sufficiently high for the proximity or contact between the band and coil to impact operation of the coil in use, for example carbon fibre, which may cause electrical shorts between the coil windings. Preferably the sheet is formed from a material having the same degree of electrical conductivity as the filament, or substantially so, under the operating conditions of the magnet, at least. In some embodiments, however, the sheet is formed from a material that is less electrically conductive than the material from which the at least one elongate filament is formed.

It will be understood that the sheet may be formed from a single layer or multiple layers. In multiple-layer embodiments, each layer may be wound together with one or more other layers, or may be wound individually. Any layer of the sheet may be formed from any one of the more sheet materials described in this disclosure. Any two or more layers of the sheet may be formed from the same material, or different materials. Any two or more layers of the sheet may have the same thickness or different thicknesses.

The sheet may be formed from a material that provides electrical insulation by virtue of a high electrical breakdown criterion. This criterion may be understood as a specific condition or threshold at which the insulating material fails. This loss in electrical resistance of the material may be referred to as electrical breakdown. The condition may be defined in terms of a specific electric field strength. The sheet material, preferably following any impregnation, typically has a breakdown criterion, at least at cryogenic temperatures, greater than 10 kVmm⁻¹. temperatures. The chosen sheet material may, for example, have this minimum breakdown criterion value at a temperature of 4.2 K, or in a range of magnet operating temperatures.

In embodiments wherein the coil is impregnated, for instance with a filler material such as an epoxy resin, the breakdown condition may be determined not just by the sheet itself but by the composite material properties of the impregnated coil assembly.

In some cases, a breakdown condition value may be predetermined or specified for a provided insulating sheet at room temperature and/or higher temperatures. Materials suitable for the purpose of insulation without in-situ impregnation as part of the process typically have breakdown condition values specified for the material at room temperature and/or higher temperatures, in the range 15-70 kVmm⁻¹. The sheet may accordingly be formed from a material having a breakdown condition value in this range.

In some embodiments, the superconducting magnet coil comprises one or more wires comprising the superconducting material. As alluded to above, the method may be used to reinforce superconducting magnet coils of various types and having various winding arrangements. In some cases, the coil may have a plurality of turns of superconducting wire wound on a former. Where the coil comprises wires, it is particularly advantageous to use a sheet to prevent the strands being disposed between the wires unintentionally as a result of the winding tension. It will be understood that, in the context of superconducting magnet coil construction, the term “wires” typically refers to materials in the form of thin flexible threads or rods, typically with a round or substantially round cross-section, or a cross section that is rectangular or substantially so.

Alternatively, some superconducting magnet coils comprise one or more wound lengths of tape comprising the superconducting material or formed therefrom. In such embodiments, the magnet coil, and particularly each of its coil turns, is typically provided as a reel of such tape. A tape in this context may be understood as referring to a narrow strip of material, typically having a rectangular or substantially rectangular cross-section perpendicular to its length.

The superconducting material may, in some embodiments, be a high-temperature superconductor, HTS, material. This is typically operatively defined as a material that behaves as a superconductor at a temperature greater than 77 K. In preferred embodiments, the said HTS material is a bismuth strontium calcium copper oxide, BSCCO, material, more preferably Bi2212. It will be understood that this refers to the specific type of BSSCO having the chemical formula Bi₂Sr₂CaCu₂O₈.

Alternatively, the superconducting material is, in some embodiments, a low-temperature superconductor, LTS, material. Low-temperature superconductors may be similarly operatively defined as materials with a critical temperature below 30 K.

The method of reinforcing the magnet coil, and in particular the step of obtaining the superconducting magnet coil itself, may comprise forming the superconductive coil from a wound coil of unreacted material. Therefore, in some embodiments, the obtaining the superconducting magnet coil comprises winding a plurality of turns of a precursor material on the first former, and heating the wound turns of the precursor material to a temperature greater than a predetermined elevated temperature so as to form the plurality of turns of the superconducting material. In some embodiments, such as those in which the superconducting material comprises an HTS material such as Bi2212, this is performed in an oxygen-rich environment. Other superconductive materials, such as niobium-tin, may not require a particular gas environment in their production, as the reaction that forms the superconductor in such cases typically occurs only between components already present in the precursor wire.

The precursor material may be understood generally to refer to a substance from which another is formed, in this case a material from which the superconductive material is to be formed. Various precursor materials are available for forming different superconductor materials. In some preferred embodiments such as those incorporating a BSCCO material in the superconducting magnet, the precursor material may be provided in the form of an unreacted wire. Typically, this may comprise a powder contained within a silver matrix. When the wire is reacted by way of elevating the temperature in the said gas environment conditions, the powder typically forms the superconducting ceramic. For the aforementioned HTS material, the predetermined elevated temperature may be 900° C. For other superconductive materials to be formed from an appropriate precursor, the elevated temperature may be lower. For example, niobium-tin superconductors may be formed by reacting a precursor wire at lower temperatures than this.

Typically the said heating is performed prior to the said winding of the at least one elongate filament. Such an ordering of method steps is appropriate if the at least one elongate filament is formed from or comprises a material that will be damaged or compromised by the high-temperature treatment or reaction. For example, typically carbon fibres cannot withstand the reaction conditions for forming BSCCO superconductors.

Alternatively, the said heating may be performed subsequent to the said winding of the at least one elongate filament. This is an appropriate approach if the filament material is compatible with the high-temperature reaction conditions, for example alumina fibres.

In embodiments wherein a sheet of material is wound around the external circumference of the coil, the heating can similarly be performed before or after the sheet is wound. If the sheet comprises materials that will or are likely to be damaged or compromised by the superconductor baking reaction, for example carbon fibre cloth, heating may be performed beforehand. If the sheet of material is compatible with the heating process, however, processes, such as the aforementioned HTS baking treatment, may be performed after the sheet is wound.

In some embodiments the method further comprises winding a layer of heat-dissipating material around the external circumferential surface of the coil prior to winding the at least one elongate filament, or at least prior to disposing the band of filament onto the coil. A heat-dissipating material may be thought of as a material that possesses suitable thermal properties, such as thermal conductivity and/or specific heat, for conducting heat generated when the coil is in use. The heat-dissipating layer may comprise a sheet, fabric, or cloth as described earlier, and may comprise multiple layers of such sheets and the like.

In some embodiments, the heat-dissipating material is or comprises a metal material. Additionally, the heat-dissipating layer may comprise at least one further layer of at least one metal or non-metal material. Each of the one or more further layers may be formed from or comprise a material different from or the same as the metal material.

Typically the method further comprises impregnating the coil and band of filament with a filler material, and hardening the filler material. The hardening process may comprise a curing process, that is hardening by a chemical process. This is appropriate, typically, if the filler comprises a resin material for example. Additionally or alternatively, a wax material may be used as or comprised by the filler material. In such cases the wax may be impregnated into the assembly azimuthal material and hardened by cooling.

In some embodiments where a filler material is used in this way, the method may further comprise providing a hardened filler material such as a cured resin or solidified wax disposed over the external circumferential surface of the coil so as to define an external circumferential surface of the hardened filler material. The method may then comprise forming one or more grooves in the external circumferential surface of the hardened filler material, and then winding the at least one elongate filament into the one or more grooves so as to form the band of filament. The method may then additionally comprise disposing further filler material around the at least one elongate filament, typically so as to contact or at least partially envelope the elongate filament, and hardening, through example by way of curing or solidifying, the further filler material.

Alternatively or additionally, the method may further comprise impregnating the at least one filament with a further filler material such as a resin prior to the winding of the at least one filament. It will be understood that various modes of providing a reinforced coil assembly comprising a resin or other filler material may be performed using a filler application procedure that are known in the art.

In accordance with a fourth aspect of the invention there is provided a reinforced superconducting magnet coil produced by a method according to any of the first, second, and third aspects.

In accordance with a fifth aspect of the invention there is provided a reinforced superconducting magnet coil, comprising: a superconducting magnet coil; a band of filament that is disposed around the external circumferential surface of the coil and, when the coil is in use, resists radial expansion of the superconducting magnet turns; wherein the band of filament comprises a material having an elastic modulus greater than 2.2×10¹¹ Pa, a yield strength greater than 6×10⁸ Pa, and a density less than 4×10³ kgm⁻³, the reinforced superconducting magnet coil further comprising one or more sheets of material between the external circumferential surface of the coil and the band of filament.

In this way a reinforced superconducting magnet coil is provided, whereby the reinforcement is provided through high-modulus, high-strength filaments without the mass or thermal bulk that steel reinforcement members have conventionally contributed to coil assemblies.

Typically, the strand tension when the magnet is not in use, or otherwise when not subjected to other forces or stresses, is that at which it is wound, which is typically at least 10×10⁶ Pa as described in relation to the preceding aspects. However, typically the tension within the strands varies in use, in particular because of the magnetic forces exerted upon the coils that the aspects of this disclosure are directed at resisting or alleviating. In preferred embodiments of any of the aspects described in this disclosure, the axial extent of the reinforcement band of filament is typically not excessive, and most preferably does not extend unnecessarily beyond the axial extent of a coil turn being reinforced by a given section of the band. Preferably, therefore, at any given point along at least a portion of the superconducting magnet coil, or at all points along the portion preferably, the band of filament has an axial extent less than or equal to the axial extent of the superconducting magnet coil. This condition may be met along the wound length, that is along the curve defined by the plurality of turns of the coil. In some embodiments, the portion is 50% of the wound length, more preferably 75%, more preferably still 80%, 85%, 90% or 95%. Most preferably the axial extent of the reinforcement band is so limited along the entire circumferential length of the magnet coil, or substantially all of it.

It will be understood that the said portion need not be continuous. For example, the portion in which the axial extent of the band is limited may contain a discontinuity, or a plurality of discontinuities, in which the band extends axially beyond the axial extent of the coil winding.

The axial extent of the superconducting magnet coil may be understood as referring to the axial extent of the coil and that of the band at the same point on the coil. For example, if either or both of the reinforcement band and magnet coil vary in their axial extent along one or more points along the wound or circumferential length of the reinforced coil, in the said portion, the band is typically less axially extensive than the part of the coil over which it lies in a radial direction.

In such embodiments, the limited extent of the band avoids the disadvantages of having the band extend axially beyond the coil windings around which they are disposed. These advantages include, for example, being obstructive during the production, use, and/or maintenance of the coil. It is possible to achieve this benefit without compromising the mechanical support capabilities of the band by way of using filaments having the aforementioned material properties. In particular the winding of these fibres under tension so as to provide an appropriately constrictive reinforcement band provides beneficial hoop stress support.

In some embodiments, the reinforced coil may comprise a wrapped layer outside the coil, that is on the inside of the reinforcement band. The one or more sheets of material may be disposed such that the at least one elongate strand or filament is wound around an external circumferential surface of the wound sheet of material.

The sheet preferably comprises a fabric woven from glass fibre filaments, carbon fibre filaments, or alumina fibre filaments. Most preferably the sheet is formed from a material that is less electrically conductive than the material from which the at least one elongate filament is formed. The degrees of electrical and thermal conductivity described in this disclosure may be understood as referring to the thermal and electrical properties of the materials in question during the operating and/or manufacture of the reinforced superconducting magnet coil.

### BRIEF DESCRIPTION OF THE DRAWINGS

Examples of the present invention will now be described, with reference to the accompanying drawings, wherein like reference numerals indicate like features, and in which:

FIG. 1 shows a flow diagram representing a first example method according to the invention;

FIG. 2 shows a flow diagram representing a second example method according to the invention;

FIG. 3 is a schematic drawing showing a perspective view of reinforcement of an example superconducting magnet coil according to the invention at three stages;

FIG. 4 is a schematic drawing showing a cross-sectional view of an outer circumferential portion of a magnet coil comprising a reinforcement band;

FIG. 5 is a schematic drawing showing a cross-sectional view similar to that of FIG. 4, for a further example reinforced magnet coil according to the invention;

FIG. 6 is a schematic cross-sectional drawing showing a further example reinforced magnet coil portion according to the invention;

FIG. 7 is a schematic drawing showing a cross-sectional view of an outer circumferential portion, similar to FIG. 4, including an alternative magnet coil;

FIG. 8 is a schematic drawing showing a cross-sectional view of an outer circumferential portion, similar to FIG. 5, including an alternative magnet coil;

FIG. 9 is a schematic drawing showing a cross-sectional view of an outer circumferential portion, similar to FIG. 6, including an alternative magnet coil;

FIG. 10 is a schematic drawing showing a cross-sectional view of an outer circumferential portion of a further example reinforced superconducting magnet comprising a pancake coil;

FIG. 11 is a schematic cross-sectional drawing showing a further example reinforced magnet coil portion according to the invention; and

FIG. 12 is a schematic cross-sectional drawing showing a further example reinforced magnet coil portion, similar to that of FIG. 11 and including an alternative magnet coil.

### DESCRIPTION OF EMBODIMENTS

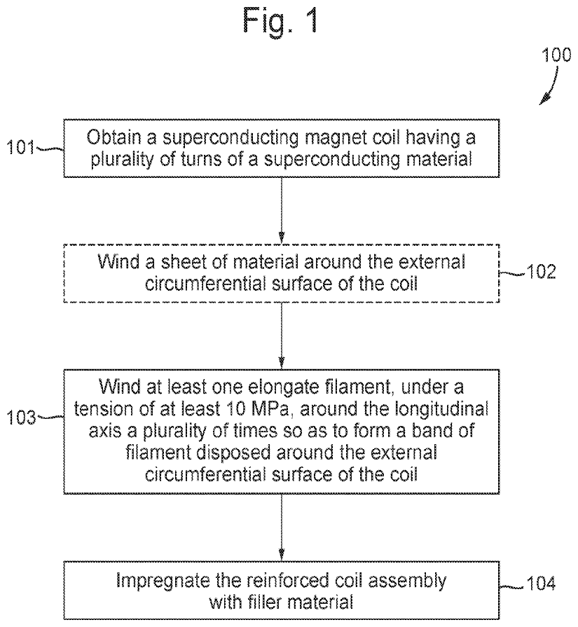

With reference to the accompanying drawings, example methods of reinforcing a superconducting magnet coil, and example reinforced superconducting magnetic coils according to the invention are now described. FIG. 1 shows the steps of a first example magnet coil reinforcement method 100. At step 101 a superconducting magnet coil is obtained. In the present example the magnet coil is provided as a superconducting coil prior to the performance of the subsequently described steps. However, as will be described in greater detail later in this disclosure, the coil may be provided in the form of wound turns of a precursor material that are suitable for being subsequently treated in order to render the wound material superconductive.

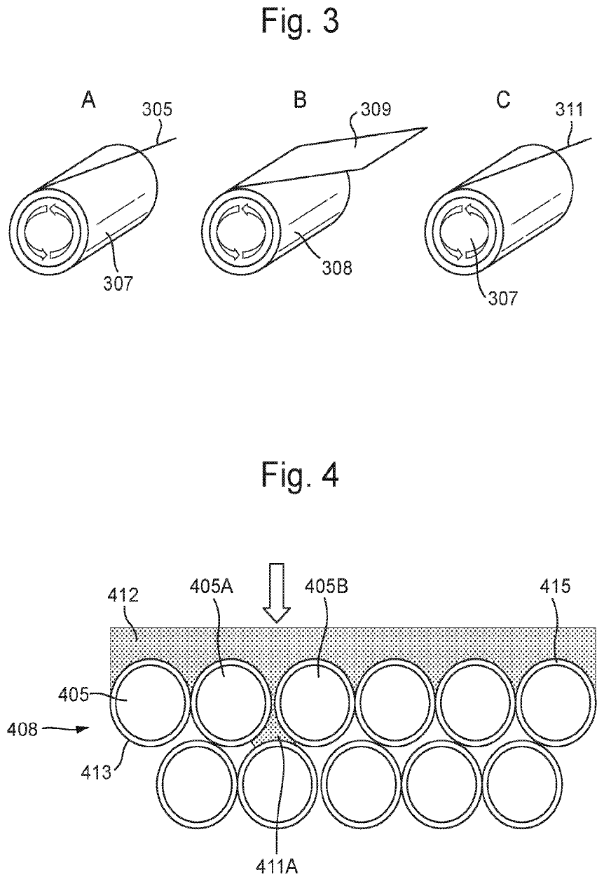

In the present example, the superconducting magnet coil may be obtained by way of winding a length of superconducting material onto a former having a longitudinal axis. This is illustrated at stage A in FIG. 3, which shows a length of superconducting material 305 being wound onto a former 307 in the present example. As is well understood in the art, the superconductor, which comprises a bundle of wires of superconducting material 305 in the present example, is traversed along the longitudinal axis of the former 307 as the former is rotated in order to produce a coil 408 wound around the former.

Optionally, at step 102, the external circumference of the coil may be wrapped with a sheet of material 309. In the present example this may be one or more sheets or layers of fibre cloth or other material. The layer 309 may comprise a continuous sheet or may be formed from multiple discontinuous bands or tapes, or may be wound from a continuous band, tape, or otherwise some form of wound length with multiple turns about the coil 408.

At step 103 an elongate filament of high-modulus material is wound around the outside of the coil 408, and outside of the intermediate layer 309 if one has been applied as shown in FIG. 3. In the present example the filament is applied by way of winding a strand comprising a plurality of alumina fibre filaments 311 as shown at stage C in FIG. 3. The former 307 is again rotated as at stages A and B. During this stage the strand or tow 311 of fibres is traversed along the longitudinal axis of the former 307 and coil 408 in order to produce a band of filaments wound under tension. The tension put upon the filament strands during the winding is at least 10 MPa. Thus the band of filament is disposed around the external circumferential surface of the coil. In the example illustrated in FIG. 3, the band of filament is disposed around the outside of the layer 309 also.

Other high-modulus filaments may be used, such as carbon fibre filaments.

At step 104 the assembly comprising the superconducting coil 408, reinforcement band of filament, and optionally the wound intermediate layer 309, is impregnated with a resin or other filler material.

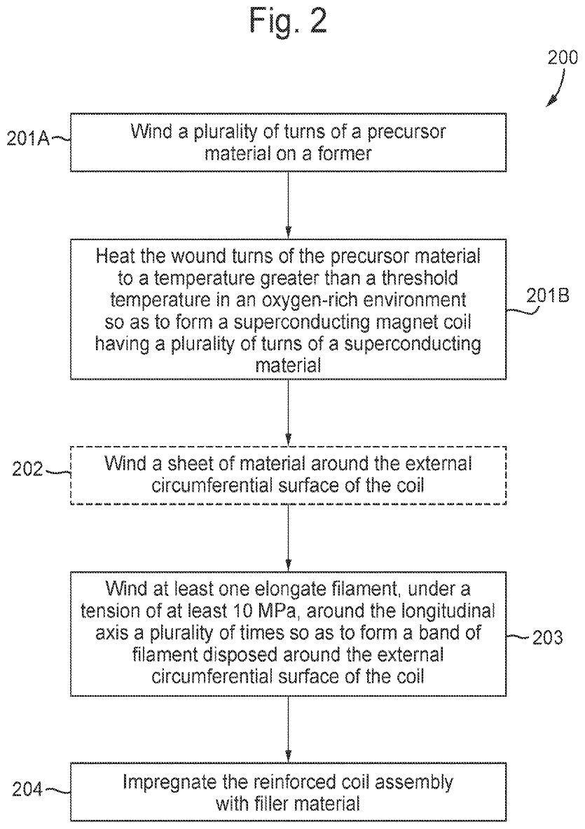

FIG. 2 shows a second example method 200 in which a reinforced magnet coil is produced. The method is similar to the first example method, and additionally includes steps to produce the superconducting magnet coil itself, starting from a precursor material.

At step 201A the precursor material, which in the present example is unreacted wire suitable for being reacted to produce a high-temperature superconductor (HTS) wire. The wire is bundled into windings each containing a plurality of wires. Similarly to the winding shown at stage A in FIG. 3, at step 201a the unreacted wire is wound a plurality of times around a longitudinal axis of a former in order to form the turns of a coil.

At step 201B the superconductive magnet coil is obtained by way of heating the wound turns of the unreacted wire to a temperature greater than a threshold temperature in an oxygen-rich environment. In the present example the threshold temperature is 900° C. This corresponds to the thermal conditions typically used to produce certain HTS materials including bismuth strontium calcium copper oxide (BSCCO) materials. However, other superconductor materials are envisaged, such as niobium-tin (Nb3Sn), which is typically reacted at lower temperatures during its production.

Thereafter at step 202 the sheet of material, which, as with the first example, may be formed from the same or similar materials to the elongate fibres, or may be formed from different materials including metals, is optionally wound around the external circumferential surface of the coil.

Subsequently at step 203 the elongate fibres are wound around the produced coil in order to form the band of reinforcing filament.

It will be understood that, although in these first and second examples a strand comprising a plurality of filaments bundled substantially parallel to one another is used, the method may alternatively be performed using individual filaments. However, strands or tows of multiple filaments are preferentially used in order to produce the reinforcement bands more quickly.

In a variation upon the second example illustrated in FIG. 2, step 201B in which the precursor material is treated in order to render it superconductive, may be performed subsequent to the steps of winding the intermediate sheet 202 and winding the filament band 203. It will be understood that the order of steps illustrated in FIG. 2 is suitable when the material of the filament, and the sheet if one is being used, is compatible with the conditions to which the assembly is subjected at step 201b. For example, if the elongate filaments are formed from alumina fibre, then the filament may be wound at step 203 prior to the heating of the precursor material at 201b, since the alumina filaments can withstand the 900° C. process for producing certain HTS materials. However, if alternative fibre materials such as carbon fibres are used, then it is preferable to perform the heating step of 201b prior to the winding of those materials.

FIG. 4 shows a section of a magnet coil reinforced according to a further example that demonstrates an issue that can occur with winding high-modulus fibres directly onto the outer windings without any intermediate layer therebetween. The diagram shows a cross-section across a plane perpendicular to the direction of wound Bi2212 superconducting wires 408. In the present example each individual wire 408 is insulated with a layer of a ceramic material 413.

A band of wound fibres 412 is disposed over the outer circumferential surface 415 defined by the outward facing surfaces of the wires 408 in the coil windings.

It is possible that this surface 415 may in some cases not be entirely continuous, as demonstrated for example by the gap between adjacent wire windings 405A, 405B. These gaps may be present prior to the winding of the filament, and may also be created and/or widened as a result of the filament being wound around the coil. The presence of such gaps, as shown in FIG. 4, can lead to turns of the filament 411A falling between the turns of the wire 405A, 405B as the filament is wound under tension.

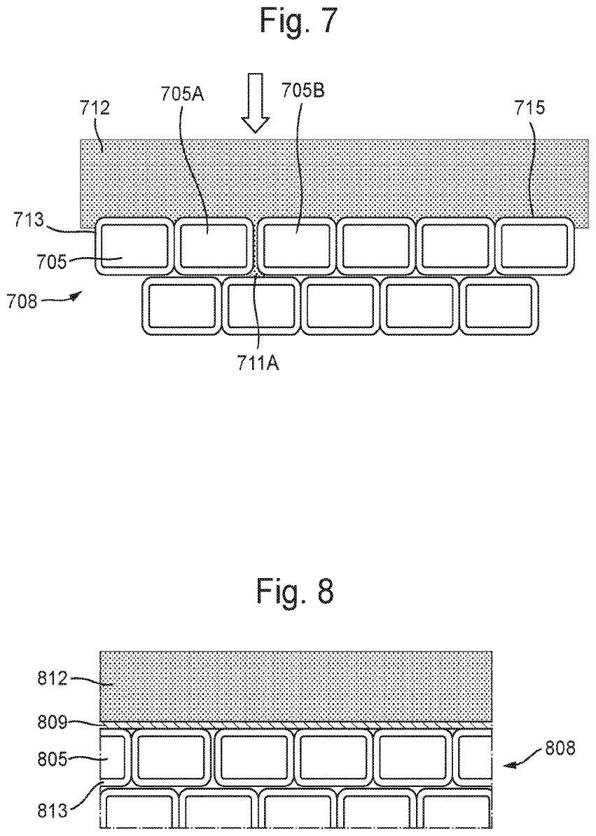

FIG. 7 shows an alternative example in which the coil 708 is formed as a layer-wound rectangular wire arrangement. As with the immediately preceding example, the winding of fibres onto the outer surface 715 of the outermost layer of wires causes a portion of the fibres 711A to become interposed between two adjacent rectangular cross-section wires 705A, 705B.

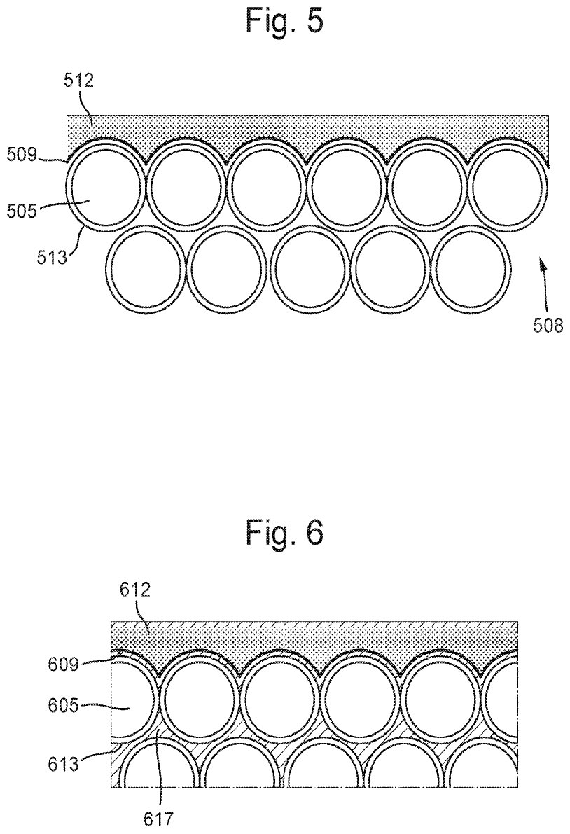

The interposing of a sheet layer as illustrated at each of FIG. 5 and FIG. 8 can prevent the unwanted and uncontrolled ingress of strands or filaments into the coil windings. The cross section shown in FIG. 5 is similar to that illustrated in FIG. 4. Likewise the cross section shown in FIG. 8 is similar to that illustrated in FIG. 7.

In this example, a fibre sheet, which in this case is woven from alumina fibres, is wrapped as a layer 509 around the coil 508. This wrapping has been performed prior to the winding of filaments, which in this example are also alumina fibre filaments 511, around the coil. Thus the layer of fibres 512 is prevented from falling into the winding pack 508 during its application to the coil.

Additionally or alternatively, a layer of a material having particular properties such as electrical insulation or heat conductivity is applied in the intervening layer 509. Indeed, the layer 509 may comprise one or a plurality of layers of the same or different materials.

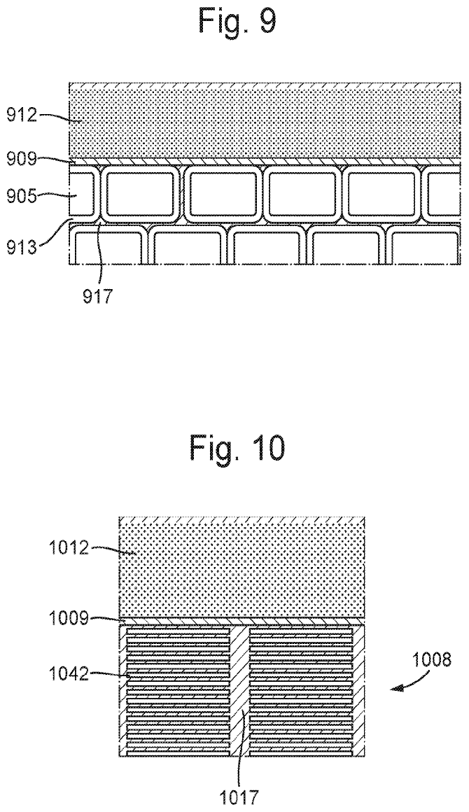

FIG. 6 shows the example coil of FIG. 5 with a similar cross-sectional view at a subsequent stage whereby the assembly has been impregnated with a resin or other similar filler material. It can be seen that the resin 617 is disposed between the turns of the Bi2212 wire 605. The layer of filaments 612 has likewise been impregnated with resin. Similarly, FIG. 9 likewise shows the example coil of FIG. 8 at the stage of having been filled with resin.

In the above-described example the assembly is impregnated after the application of the sheet layer 609 and the reinforcement band 612. However, additionally or alternatively the coil 608 may be impregnated with resin prior to the application of the sheet and/or the filaments thereto, and the cured resin may be machined so as to provide a surface profile suitable for having the filaments wound onto it. Such a process may involve winding a sheet or layer of filaments, filament cloth, or other suitable material before or after the said filling with resin. Moreover in examples wherein filaments are wound onto an already impregnated coil, wet winding of further sheet layers of filaments may be performed.

As alluded to above, in examples wherein the high-modulus filaments have a moderate degree of electrical conductivity, such as carbon fibres, which may impact the operation of the coil, then providing a sheet layer 609 having comparatively high electrical resistance also prevents the filaments from causing electrical shorts between the wires of the coil 608.

In addition to methods of producing a reinforced coil by machining a resin surface, wrapping with high-modulus fibres, and impregnating with filler, wet winding the fibre onto the machine surface, and wrapping the wound superconducting coil with the fibre and then impregnating both the coil and high-modulus fibre together, it is also envisaged that the band of filaments may be constructed independently, or separately, from the coil. For instance, a shell of high-modulus fibres may be formed either by wet winding or winding and subsequently impregnating the fibres on a removable former and then fitting the completed shell over the superconducting coil. In such examples, relatively electrically resistive materials may also be advantageous or necessary between the fibre and superconducting wires for the prevention of electrical shorts between wires of the coil.

The combination of a reinforcement band comprising high-modulus filaments with a metal intervening layer advantageously combines the thermal properties of metals with the strength, stiffness, and low density of the reinforcement band. These components may act together in such examples to enable a strongly reinforced coil to be provided without the need for thick, high-mass steel reinforcements, while also benefitting from the thermal properties of metal materials.

In FIG. 10 the principle of a reinforced magnet coil comprising an intermediate layer, corresponding to those examples shown in FIGS. 6 and 9, is depicted. In this alternative arrangement, the coil 1008 is provided in the form of pancake-wound superconductive tapes.

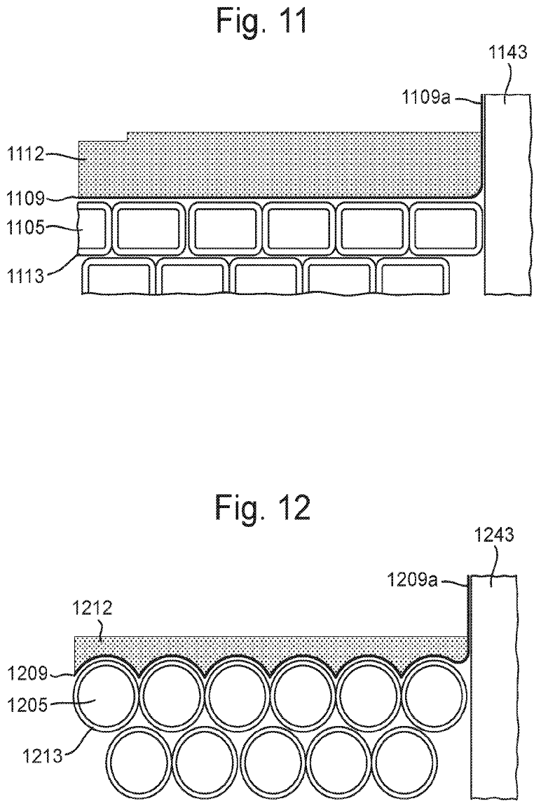

FIGS. 11 and 12 illustrate, for rectangular and round coil wires, respectively, an alternative mode of applying the sheet and filament band. In these examples, a magnet coil assembly is provided which additionally comprises an end flange 1143, 1243 that protrudes radially out, beyond the coil. The flange is affixed to the assembly prior to winding the sheet, and is arranged to abut a side 1144 of the coil that is orthogonal to its longitudinal axis. It is typically provided in the form of a ring, typically comprising a metal material or another rigid material, with an outer circumference marginally greater than that of the coil to which it is attached.

The dimensions of the sheet 1109 are sufficient for the extent of the wound sheet in the magnet longitudinal direction to be exceed that of the coil. The additional portion 1109a of the sheet, which would overhang the coil, is caused to bend outwards and be disposed against a surface of the winding end flange when the sheet 1109 is laid over the coil wires 1105.

Since FIGS. 11 and 12 depict only a part of a coil, only one end flange is shown for each example. However, preferably the coil of superconducting wire 1105, 1205, which is typically formed from Bi2212 and insulated by a ceramic insulation layer 1113, 1213, is provided with a flange 1143, 1243 on both sides. In this way, the sheet 1109, 1209, which may be formed from alumina fibre for example, can be disposed onto the coil in a ‘U’ shape, with the magnet coil having two sheet portions, including the depicted bent portion 1109a, 1209a, extending radially outward. The filament 1112 can then be wound within the ‘U’-channel, between the flanges, to form the reinforcement band. Providing a flanged coil and winding the reinforcement components in this manner achieves improved tension control and stability for the sheet and filament as they are wound.

1. A method of reinforcing a superconducting magnet coil, comprising:
obtaining a superconducting magnet coil having a plurality of turns of a superconducting material wound on a former having a first longitudinal axis so as to define an external circumferential surface of the coil;
winding at least one elongate filament, under a tension of at least 10×10⁶ Pa, around a second longitudinal axis a plurality of times so as to form a band of filament; and
disposing the band of filament around the external circumferential surface of the coil such that, when the coil is in use, the band of filament resists radial expansion of the superconducting magnet turns,
wherein the at least one elongate filament is formed from a material having an elastic modulus greater than 2.2×10¹¹ Pa, a yield strength greater than 6×10⁸ Pa, and a density less than 4×10³ kgm⁻³,
wherein the method further comprises, prior to the winding of the at least one elongate filament, winding a sheet of material around the external circumferential surface of the coil such that the at least one elongate filament is wound around an external circumferential surface of the wound sheet of material, and
wherein the sheet comprises a fabric woven from fibres.

2. The method according to claim 1, wherein:
the first longitudinal axis is the same as the second longitudinal axis, and
the winding of the at least one elongate filament forms the band of filament disposed around the external circumferential surface of the coil.

3. The method according to claim 1, wherein:
the second longitudinal axis is a longitudinal axis of a second former, and
the winding of the at least one elongate filament forms the band of filament around the external circumferential surface of the second former,
wherein the method further comprises removing the formed band of filament from the former and disposing it around the external circumferential surface of the coil.

4. (canceled)

5. The method according to claim 1, wherein the winding the at least one elongate filament comprises winding at least one elongate strand comprising the at least one elongate filament, under a tension of at least 10×10⁶ Pa, around the first longitudinal axis a plurality of times so as to form the band of filament, wherein each of the at least one elongate strand comprises a plurality of elongate filaments.

6. The method according to claim 5, wherein each of the at least one elongate strand comprises a plurality of carbon fibre filaments or a plurality of alumina fibre filaments.

7. The method according to claim 5, wherein the plurality of fibre filaments in the band of filament are aligned substantially circumferentially with respect to the magnet coil.

8. The method according to claim 1, wherein the sheet comprises a fabric is woven from carbon fibre filaments or alumina fibre filaments.

9. The method according to claim 1, wherein the sheet is formed from a material that is less electrically conductive than the material from which the at least one elongate filament is formed.

10. The method according to claim 1, wherein the superconducting magnet coil comprises one or more wires comprising the superconducting material, or one or more wound lengths of tape comprising the superconducting material.

11. (canceled)

12. The method according to claim 1, wherein the superconducting material is a high temperature superconductor, HTS, material a bismuth strontium calcium copper oxide, BSCCO, material.

13. (canceled)

14. The method according to claim 1, wherein the superconducting material is a low-temperature superconductor, LTS, material.

15. (canceled)

16. (canceled)

17. (canceled)

18. The method according to claim 1, further comprising winding a layer of heat-dissipating material around the external circumferential surface of the coil prior to the winding of the at least one elongate filament.

19. The method according to claim 18, wherein the heat-dissipating material comprises a metal material.

20. The method according to claim 1, wherein the method further comprises impregnating the coil and band of filament with a filler material, and hardening the filler material.

21. The method according to claim 1, wherein the method further comprises: providing a hardened filler material disposed over the external circumferential surface of the coil so as to define an external circumferential surface of the hardened filler material; forming one or grooves in the external circumferential surface of the hardened filler material; and winding the at least one elongate filament into the one or more grooves so as to form the band of filament.

22. The method according to claim 21, further comprising disposing further filler material around the at least one elongate filament, and hardening the further filler material.

23. The method according to claim 21, further comprising impregnating the at least one filament with further filler material prior to the winding of the at least one filament.

24. The reinforced superconducting magnet coil produced by the method according to claim 1.

25. A reinforced superconducting magnet coil, comprising:
a superconducting magnet coil;
a band of filament that is disposed around the external circumferential surface of the coil and, when the coil is in use, resists radial expansion of the superconducting magnet turns;
wherein the band of filament comprises a material having an elastic modulus greater than 2.2×10¹¹ Pa, a yield strength greater than 6×10⁸ Pa, and a density less than 4×10³ kgm⁻³,
the reinforced superconducting magnet coil further comprising one or more sheets of material between the external circumferential surface of the coil and the band of filament, and
wherein the sheet comprises a fabric woven from fibres.

26. (canceled)

27. (canceled)

28. (canceled)

29. (canceled)

30. The method according to claim 20, wherein the filler material is an epoxy resin.
